(19) United States
(12) Patent Application Publication
(10) Pub. No.: US 2008/0165530 A1
(43) Pub. Date: Jul. 10, 2008

(54) ILLUMINATIVE APPARATUS

(76) Inventor: Westerveld Johannes Hendrikus, Sedona, AZ (US)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/621,869

(22) Filed: Jan. 10, 2007

(51) Int. Cl. B60Q 1/26

(52) U.S. Cl. 362/227

(57) ABSTRACT

A light array includes a major light, at least one minor light and a dimmer. The minor light is connected to the major light. The dimmer connected to the major light. The dimmer is operable for adjusting the luminance of light emitted from the major and minor lights.

### BACKGROUND OF INVENTION

1. Field of Invention

The present invention relates to an illuminative apparatus and, more particularly, to a light array.

2. Related Prior Art

Referring to FIG. 1, a conventional light array includes a plurality of lights. Each of the lights includes two connective units, two sockets 5 connected to the connective units, a light tube 7 with two terminal portions inserted in the sockets 5, a transparent tube 1 for covering the light tube, two rings 6 for holding the light tube 7 firmly in the transparent tube 1 and two pairs of caps 2 for covering the ends of the transparent tubes 1. Each of the caps 2 includes a plurality of rods inserted in apertures defined in the transparent tube 1. Each connective unit of a light can be used to receive a plug 8 leading to a power supply or a plug leading to a connective unit of another light. Problems have been encountered the assembly and use of this conventional light array. Firstly, it is troublesome to assemble all these elements. Therefore, it requires a lot of energy in maintenance. Secondly, the structure of each light is complicated. Therefore, the cost of each light is high. Thirdly, two lights are interconnected by a cable that is exposed and aesthetically unpleasant. Fourthly, the luminance of the light emitted from the light tube cannot be adjusted. Therefore, the illuminative effect of the light tube is dull.

The present invention is therefore intended to obviate or at least alleviate the problems encountered in prior art.

### SUMMARY OF INVENTION

According to the present invention, a light array includes a major light, at least one minor light and a dimmer. The minor light is connected to the major light. The dimmer connected to the major light. The dimmer is operable for adjusting the luminance of light emitted from the major and minor lights.

An advantage of the light array of the present invention is the adjustability of the luminance of the light emitted from it.

Another advantage of the light array of the present invention is a simple structure and therefore a low cost.

Another advantage of the light array of the present invention is easy assembly and therefore easy maintenance.

Another advantage of the light array of the present invention is an aesthetically pleasing appearance.

Other advantages and features of the present invention will become apparent from the following description referring to the drawings.

### BRIEF DESCRIPTION OF DRAWINGS

The present invention will be described via detailed illustration of embodiments in view of a conventional device referring to the drawings.

FIG. 1 is an exploded view of a conventional light array.

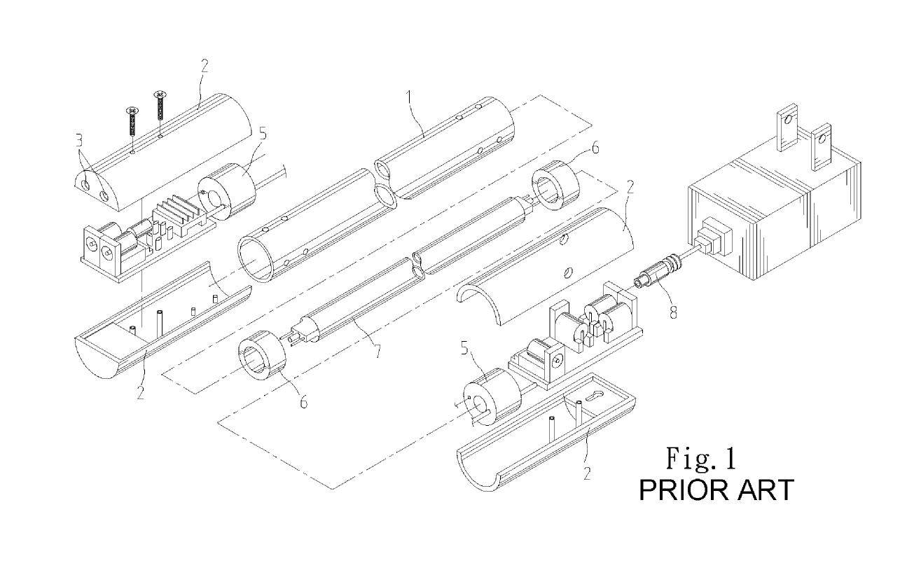

FIG. 2 is a perspective view of a light array according to a first embodiment of the present invention.

FIG. 3 is an exploded view of the light array shown in FIG. 2.

FIG. 4 is an enlarged partial cross-sectional view of the light array shown in FIG. 2.

FIG. 5 is a block diagram of the light array shown in FIG. 2.

FIG. 6 is an exploded view of a light array according to a second embodiment of the present invention.

FIG. 7 is a perspective view of the light array shown in FIG. 6.

FIG. 8 is a perspective view of the light array in another position than shown in FIG. 7.

### DETAILED DESCRIPTION OF EMBODIMENTS

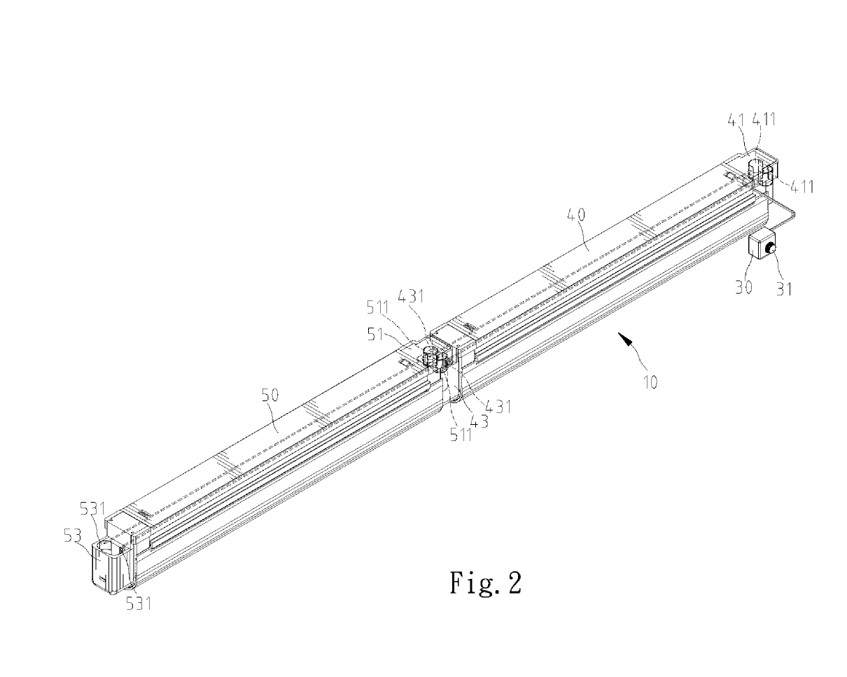

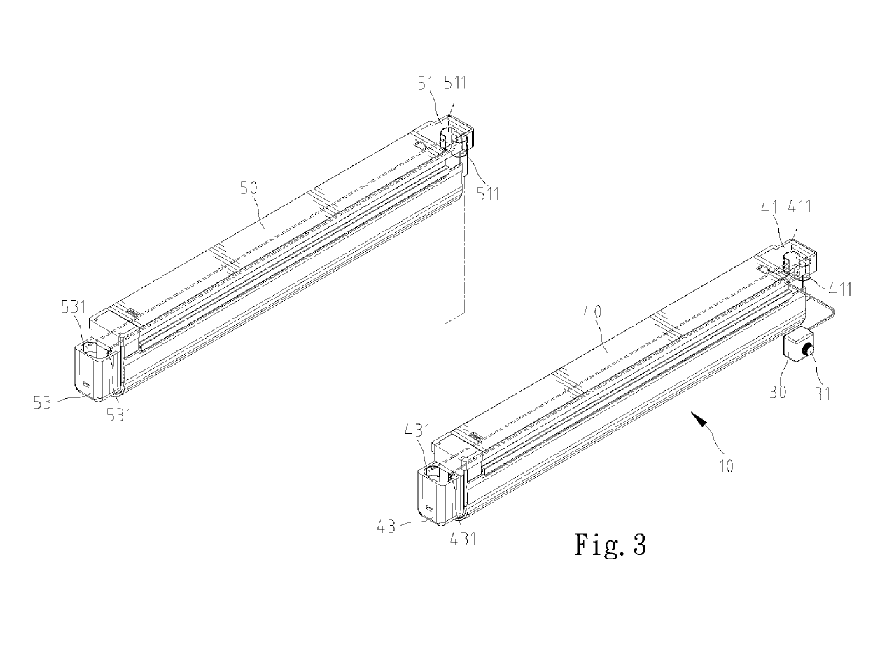

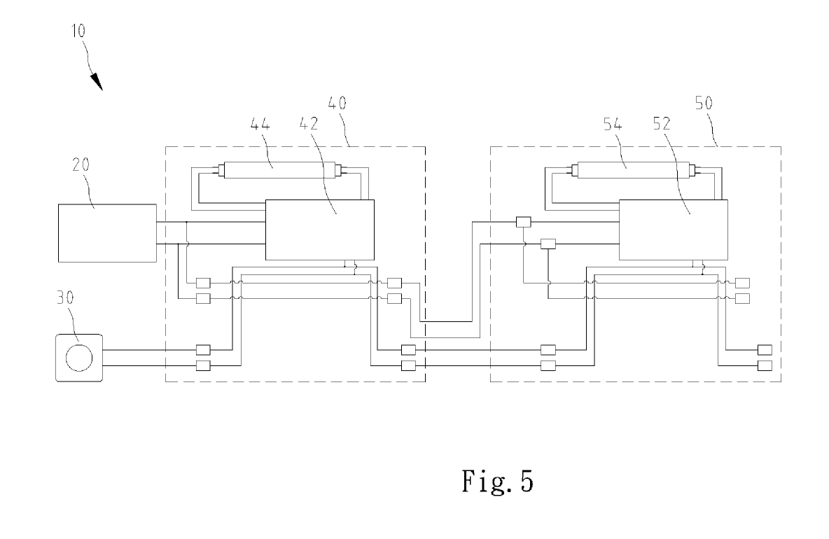

Shown in FIGS. 2 through 5 is a light array 10 according to a first embodiment of the present invention. The light array includes a major light 40, at least one minor light 50 connected to the major light 40 in parallel and a dimmer 30 connected to the major light 40.

The major light 40 includes a first connective unit 41 at an end and a second connective unit 43 at an opposite end. The first connective unit 41 is preferably an 8-figured plug extending perpendicular to the major light 40. The second connective unit 43 is preferably an oval socket defined in perpendicular to the major light 40. A lamp 44 is provided between the ends of the major light 40. The major light 40 is provided with a ballast 42. The first connective unit 41 can be connected to an alternating current (or “AC”) power supply. The first connective unit 41 includes two conductive elements 411 that are preferably U-shaped elements of copper. The second connective unit 43 includes two conductive elements 431 that are preferably arched elements of copper.

The dimmer 30 is connected to the conductive elements 411 of the first connective unit 41. The dimmer 30 is energized by DC from at least one battery 20. The dimmer 30 includes a knob 31 operable to adjust the luminance of the light emitted from each of the lights of the light array 10.

The minor light 50 include a first connective unit 51 at an end and a second connective unit 53 at an opposite end. Preferably, the first connective unit 51 of the minor light 50 is an 8-figured plug extending perpendicular to the minor light 50. The 8-figured plug 51 can be fit in the oval socket 43 of the major light 40. Thus, the lights 50 and 40 will not be disconnected when they are pulled longitudinally. The minor light 50 is provided with a ballast 52. The first connective unit 51 of the minor light 50 includes two conductive elements 511 that are preferably U-shaped elements of copper.

Preferably, the second conductive portion 53 is an oval socket defined perpendicular to the minor light 50. The oval socket 53 can receive the 8-figured plug 51 of another minor light 50. The second connective unit 53 of the minor light 50 includes two conductive elements 531 that are preferably arched elements of copper.

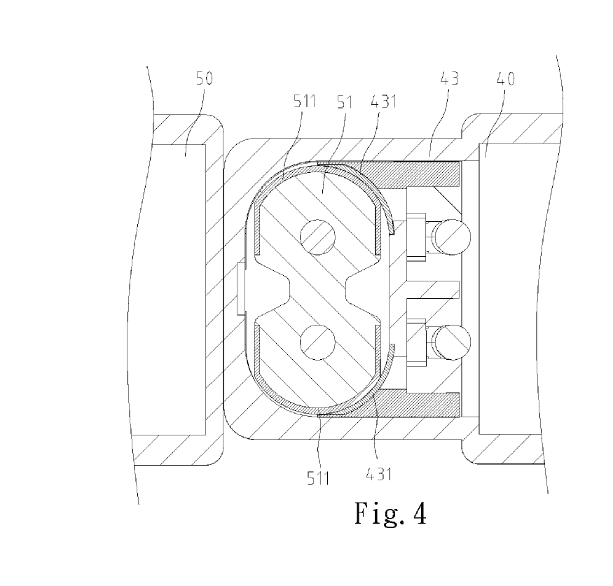

Referring to FIG. 4, the second connective unit 43 of the major light 40 is connected to the first conductive portion 51 of the minor light 50. In detail, the conductive elements 431 of the major light 40 contact the conductive elements 511 of the minor light 50. The major light 40 passes the energizing electricity to the minor light 50 so that the minor light 50 illuminates as well as the major light 40. Furthermore, the major light 40 provides the luminance-representing signals to the minor light 50 so that the minor light 50 provides the same luminance as the major light 40 does.

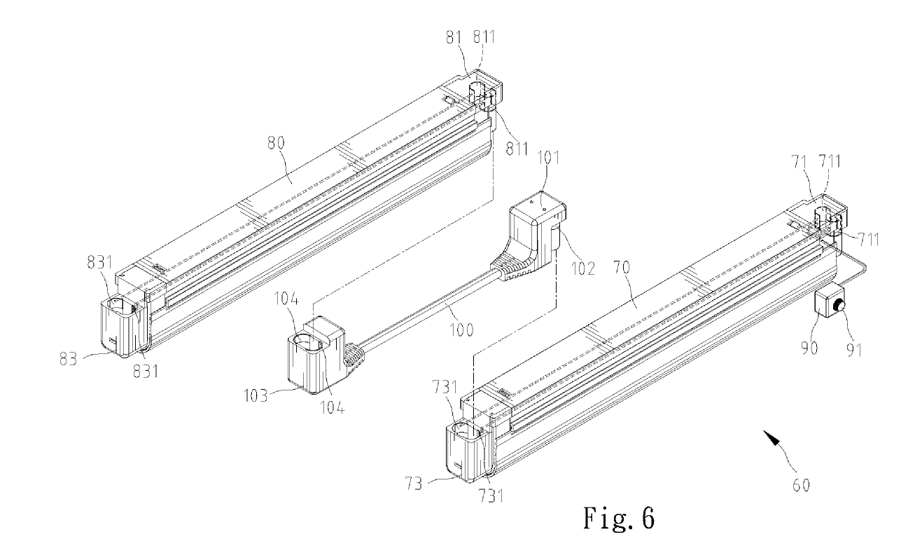

Shown in FIGS. 6 through 8 is a light array 60 according to a second embodiment of the present invention. The light array includes a major light 70, at least one minor light 80, a dimmer 90 connected to the major light 70 and at least one connector 100 for connecting the minor light 80 to the major light 70 in parallel.

The major light 70 include a first connective unit 71 at an end and a second connective unit 73 at an opposite end. The first connective unit 71 can be connected to an AC power supply. The first connective unit 71 includes two conductive elements 711 that are preferably U-shaped elements of copper. The second connective unit 73 includes two conductive elements 731 that are preferably arched elements of copper.

The dimmer 90 is energized by DC from at least one battery installed thereon. The dimmer 90 includes a knob 91 operable to adjust the luminance of the light emitted from each light of the light array 60.

The minor light 80 include a first connective unit 81 at an end and a second connective unit 83 at an opposite end. The first connective unit 81 of the minor light 80 includes two conductive elements 811 that are preferably U-shaped elements of copper. The second connective unit 83 of the minor light 80 includes two conductive elements 831 that are preferably arched elements of copper.

The connector 100 includes include a first connective unit 101 at an end and a second connective unit 103 at an opposite end. The first connective unit 101 of the connector 100 can be connected to the second connective unit 73 of the major light 70. The first connective unit 101 of the connector 100 includes two conductive elements 102 that are preferably U-shaped elements of copper. The second conductive portion 103 of the connector 100 can be connected to the first conductive portion 81 of the minor light 80. The second connective unit 103 of the connector 100 includes two conductive elements 104 that are preferably arched elements of copper.

The second conductive portion 83 of the minor light 80 can be connected to the first conductive portion 81 of another minor light 80.

The conductive elements 731 of the major light 70 contact the conductive elements 102 of the connector 100. The conductive elements 104 of the connector 100 contact the conductive elements 811 of the minor light 80. The major light 70 passes the energizing electricity to the minor light 80 through the connector 100 so that the minor light 80 illuminates as well as the major light 70. Furthermore, the major light 70 provides the luminance-representing signals to the minor light 80 through the connector 100 so that the minor light 80 provides the same luminance as the major light 70 does.

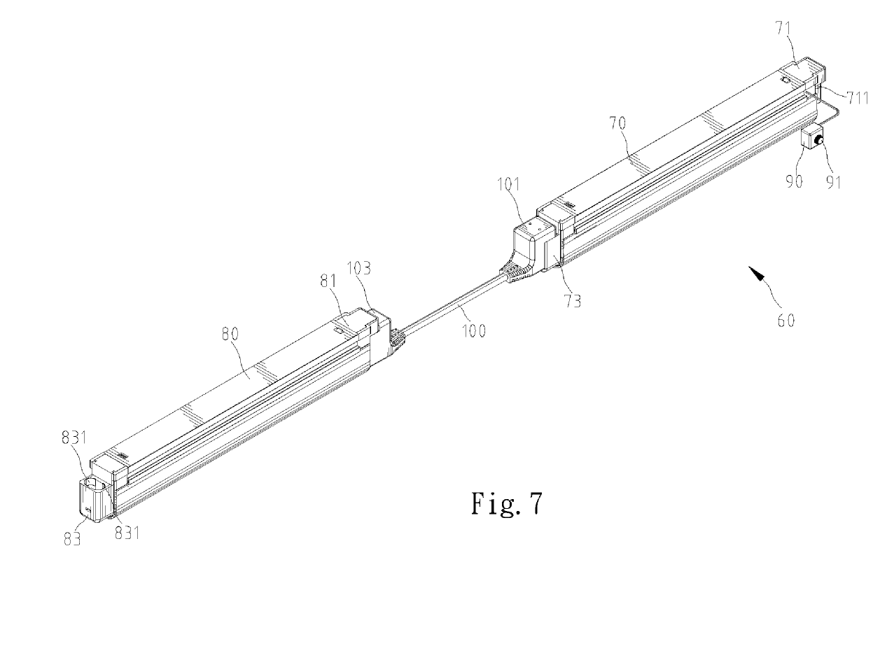

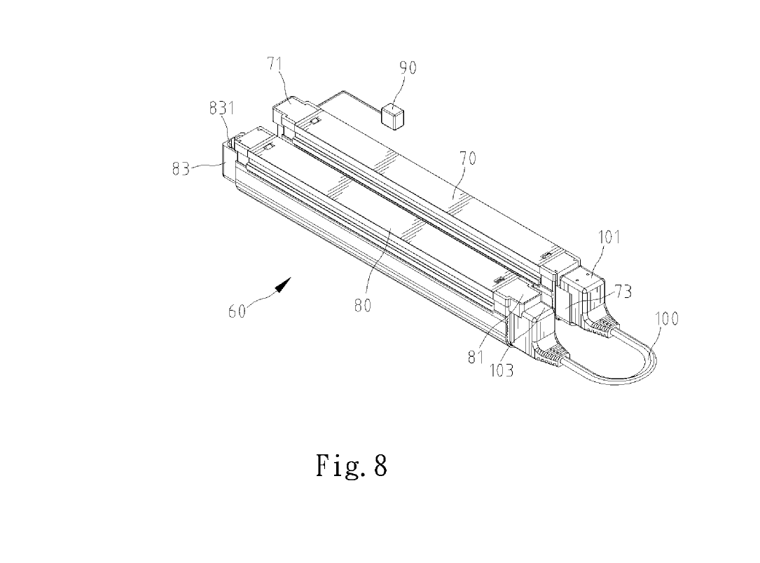

Referring to FIGS. 7 and 8, since the connector 100 is flexible, the major light 70 and the minor light 80 can be changed between various positions relative to each other, i.e., the light array 60 can be changed between various positions.

The light array of the present invention exhibits several advantages. Firstly, the luminance of the light emitted from it can be adjusted based on environments in which it is used or illuminative effects that users would like to provide.

Secondly, the luminance of the light emitted from all of the lights of it can conveniently be adjusted via maneuvering the single dimmer.

Thirdly, the position of the light array can be adjusted for the use of the flexible connector.

The present invention has been described through the illustration of the embodiments. Those skilled in the art can derive variations from the embodiments without departing from the scope of the present invention. Hence, the embodiments shall not limit the scope of the present invention defined in the claims.

1. A light array comprising a major light, at least one minor light connected to the major light, with the major and at least one minor lights each including a ballast in the major and at least one minor lights respectively, with the ballasts being electrically connected in the major and at least one minor lights, and a dimmer connected to the major light, wherein the dimmer is operable to control the ballasts for adjusting luminance of light emitted from the major and at least one minor lights.

2. The light array according to claim 1 wherein the at least one minor light includes first and second minor lights, wherein the major light comprises a first connective unit for connection to a power supply and comprises a second connective unit, wherein the first minor light comprises a first connective unit connected to the second connective unit of the major light, wherein the second minor light has a first connective unit, wherein the first minor light further comprises a second connective unit connected to the first connective unit of the second minor light.

3. The light array according to claim 2 wherein the first connective unit of the major light comprises two conductive elements.

4. The light array according to claim 3 wherein the two conductive elements of the first connective unit of the major light are connected to the dimmer.

5. The light array according to claim 2 wherein the second connective unit of the major light comprises two conductive elements, wherein the first connective unit of the first minor light comprises two conductive elements connected to the two conductive elements of the second connective unit of the major light.

6. The light array according to claim 2 wherein the first connective unit of the second minor light has two conductive elements, wherein the second connective unit of the first minor light comprises two conductive elements connected to the two conductive elements of the first connective unit of the second minor light.

7. The light array according to claim 1 comprising a connector connecting the at least one minor light to the major light.

8. The light array according to claim 7 wherein the at least one minor light includes first and second minor lights, wherein the major light comprises a first connective unit for connection to a power supply and comprises a second connective unit, wherein the first minor light comprises a first connective unit, wherein the second minor light has a first connective unit, wherein the first minor light further comprises a second connective unit connected to the first connective unit of the second minor light, wherein the connector comprises a first connective unit connected to the second connective unit of the major light and comprises a second connective unit connected to the first connective unit of the first minor light.

9. The light array according to claim 8 wherein the first connective unit of the major light comprises two conductive elements.

10. The light array according to claim 8 wherein the second connective unit of the major light comprises two conductive elements, wherein the first connective unit of the connector comprises two conductive elements connected to the two conductive elements of the second connective unit of the major light.

11. The light array according to claim 8 wherein the second connective unit of the connector comprises two conductive elements, wherein the first connective unit of the first minor light comprises two conductive elements connected to the two conductive elements of the second connective unit of the connector.

12. The light array according to claim 8 wherein the light array further comprises another connector having a first connective unit, wherein the second connective unit of the first minor light comprises two conductive elements connected to the two conductive elements of the first connective unit of the other connector.

13. The light array according to claim 7 wherein the connector is flexible.

14. The light array according to claim 1 wherein the major and at least one minor light each includes first and second connective nits, wherein the first connective unit of the at least one minor light is an 8-figured plug, and the second connective unit of the major light is an oval socket receiving the 8-figured plug of the at least one minor light.

15. The light array according to claim 14 wherein the oval socket is transversely defined in the major light.

16. The light array according to claim 14 wherein the 8-figured plug is transversely formed on the at least one minor light.

17. The light array according to claim 14 wherein the at least one minor light includes first and second minor lights, wherein the second connective unit of the first minor light is an oval socket receiving the 8-figured plug of the second minor light.

18. The light array according to claim 17 wherein the oval socket is transversely defined in the first minor light.
